(19) United States
(12) Patent Application Publication
(10) Pub. No.: US 2011/0011780 A1
(43) Pub. Date: Jan. 20, 2011

(54) SYSTEM FOR IMPROVING TOTAL WATER QUALITIES IN EUTROPHICATED AND CONTAMINATED WATER AREA UTILIZING WATER PURIFYING FUNCTIONS OF VARIOUS PLANTS AND MICROORGANISMS

(76) Inventor: Yumin Izumo, Tokyo (JP)

Correspondence Address: BOYLE FREDRICKSON S.C., 840 North Plankinton Avenue, MILWAUKEE, WI, 53203, US

(21) Appl. No.: 12/521,432

(22) PCT Filed: Dec. 28, 2006
(86) PCT No.: PCT/JP2006/326411

§ 371 Date: Sep. 10, 2010

(51) Int. Cl. C02F 3/10; C02F 3/32; C02F 3/34

(52) U.S. Cl. 210/170.05

(57) ABSTRACT

A system for improving the total water qualities in an eutrophicated and contaminated water area utilizes the water purifying functions of various plants and microorganisms. The system takes the form of a floating inland with plants, which have functions of absorbing eutrophication components from the roots and thus purifying water. The system also contains an anchor for fixing the floating island to the bottom, a weight for controlling the floating conditions of the floating island, and a connecting member for connecting the floating island, the anchor and the weight together. An aquatic plant or an aerobic or anaerobic microorganism capable of absorbing eutrophication components is stuck to at least the lower part of the system in a manner suitable for the environmental conditions of the contaminated water area, thereby achieving an effect of improving the water qualities simultaneously at all of the water face, the under water part and the bottom.

### BACKGROUND OF THE INVENTION

1. Field of the Invention

The present invention is a novel water purification system for nitrogen-rich and phosphorus-rich water areas mainly caused by domestic wastewater. Without negative impact on the environment, the system combines and comprehensively uses the purification function of a variety of plants and microbes.

1. Description of the Related Art

In the lakes in Myanmar, Vietnam, South America and other countries, especially in the plateau lakes in the regions with inadequate arable lands, it is known that the residents surrounding lakes construct some unique artificial floating islands for growing vegetables by traditional methods. On the artificial floating islands constructed with the materials of tree branches, coconut shells, grasses, mud and the like, the roots of plants enter the water to absorb the nitrogen and phosphorus in the water, and part of the oxygen generated by photosynthesis is sent into the water, thus the water quality is improved. By purification, the polluted lakes caused by domestic wastewater, livestock excreta and so on are effectively disposed. The method has drawn increasing concern.

The present invention is not aimed for growing vegetables, but for water purification by building artificial floating islands on the lakes and rivers and by taking advantage of plants.

It is proposed that for water purification, the industrial artificial floating island unit should be constructed to match plants. The artificial floating island unit consists of the basic buoyancy conformation bodies and mesh conformation bodies, and the materials in current use mainly include two kinds as follows.

(1) One is the buoyancy conformation part into which the foam materials like the plastic tubes, nylon tubes, synthetic resins, and the like are stuffed.

(2) The other is mesh conformation body part which includes coconut shell fibers, natural or synthetic rubbers, plastic nets, and the like.

In addition, the EIN timber is used by the EIN Co. Ltd. as a new buoyancy material for the unit buoyancy conformation part in artificial floating island. EIN timber is a newly synthesized material made from 55% wood powder and 45% PP, PE and other waste materials. The hollow parts are stuffed with foam materials. The mesh conformation body is made from synthetic resins. These two parts are combined as an artificial floating island unit.

Also, the buoyancy construction part can be made from the low-cost waste foams and waste tires and tire tubes which possess full buoyancy and cause no potential hormone pollution to environment instead of from industrial products. The other parts are made from safe, natural materials and are combined to form the artificial floating islands for a comprehensive water disposal.

Furthermore, the proposal is shown in the following literature.

Patent Publication 1: Japanese Patent Application Laid-open No. 2004-237141.

### DISCLOSURE OF THE INVENTION

### Task to be Solved by the Invention

Firstly, in traditional methods, the tree branches, coconut shell fibers, grasses, mud and other materials to make the floating island unit will gradually rot to cause a vicious circle. When a large-scale floating island is built to dispose a large area of lake, there will be limits in terms of technology and materials.

Furthermore, the industrial materials above like nylon tubes and plastic materials to make the floating islands tend to age and to produce environmental hormones which are easily soluble in water to lead to the secondary pollution as coconut shell fiber corruption does. In addition, the cost is relatively high; for example, a floating island of 2 m×1.9 m costs about 100,000 Japanese yen so that the engineering area is limited dramatically, and the engineering of water purification in lakes and rivers can not be achieved.

Moreover, although the technique discovered in the Japanese Patent Application Laid-open No. 2004-237141 has many advantages, in fact there are still some unresolved issues in low-cost large-scale engineering.

Anyhow, for the two methods mentioned above, the technical complexity of the actual construction and the high human and economic costs, make it too difficult to dispose water on large scales.

The following problems may occur if the floating island is constructed by the above-mentioned traditional crafts.

For example, a small-scale floating island on a large lake is not current-resistant and stable enough, even if it has good water purification ability; and higher plants can not grow due to the poor stability. The resin material is limited in its strength and tends to rapidly age under sunlight, leading to the floating island itself becoming a source for secondary pollution.

Final project budget is restricted by high costs, and the required area of floating island for water purification can not be guaranteed in a certain water area. So far such technology can only be applied to the small areas like the pond or experimental waters, it is impossible to achieve the practical effects in larger lakes.

On the basis of research data, the function of plants in water purification varies, and generally the floating island to occupy at least 5.6% of the total water area can expect significant effects. Therefore, a large-scale floating island needs to be built.

Nowadays, with the rapid growth of world economy and population, the worsening water quality caused by the domestic wastewater becomes an increasing concern.

Especially to those who depend on the polluted lakes and rivers as source of the living and production, the water problem is even more serious. In order to prevent further pollution, we should take water disposal seriously as a world issue.

Most important, the proposal that takes the waste tires as the buoyancy conformation part has been identified as an effective means by using resources and wastes at a low cost and a range of effects have been confirmed. But at the same time, the polluted water areas caused by domestic wastewater will also vary with the place and time. Also, it is essential to restore the ecology while disposing polluted water bodies and the bottom pollution.

For the pollution caused by domestic wastewater, the pollutants, extent, and nature are all different, so it must be recognized that the purification measures must be implemented in accordance with the conditions like places and time, and by using diverse plants and microbes for optimal effects.

### OBJECT OF THE INVENTION

The present invention is to solve these issues unsolved by conventional techniques, and the proposal is created through accumulating results of researches, experiments and thoughts, and so on. For high efficiency and low cost, while using of renewable resources such as waste tires, the research tries to prevent the materials from bringing the negative effects on the environment. In the construction sites and based on the specific conditions, the best system is assembled for water disposal, economic benefits, landscaping and so on. The specific content follows.

1. A system for improving the total water qualities in an eutrophicated and contaminated water area utilizing the water purifying functions of various plants and microorganisms characterized by comprising a floating inland with plants to be floated on the water surface of a lake, a lagoon, a pond, a river or the like having been eutrophicated (i.e., being rich in phosphorus, nitrogen and so on) and contaminated with domestic waste water flowing thereinto wherein plants, which have functions of absorbing eutrophication components from the roots and thus purifying water, are planted and grown; an anchor for fixing the floating island with plants to the bottom; a weight for controlling the floating conditions of the floating island with plants; and a connecting member for connecting the floating island with plants, an anchor and a weight, wherein an aquatic plant or an aerobic or anaerobic microorganism capable of absorbing eutrophication components is stuck to at least any of the lower part of the floating island with plants, the anchor, the weight and the connecting member in a manner suitable for the environmental conditions of the water area in which the system is provided, thereby achieving an effect of improving the water qualities simultaneously at all of the water face, the under water part and the bottom.

2. The system for improving the total water qualities in an eutrophicated and contaminated water area utilizing the water purifying functions of various plants and microorganisms wherein as buoyancy conformation part of botanical floating island, waste tires, tire tubes, and waste foam materials are utilized.

3. The system for improving the total water qualities in an eutrophicated and contaminated water area utilizing the water purifying functions of various plants and microorganisms wherein buoyant materials such as waste resin foams are stuffed into the middle of waste tires to increase the overall buoyancy of the island.

4. The system for improving the total water qualities in an eutrophicated and contaminated water area utilizing the water purifying functions of various plants and microorganisms wherein the buoyant materials such as waste resin foams are stuffed into the middle of waste tires, and a metal netting made from stainless steel is used.

5. The system for improving the total water qualities in an eutrophicated and contaminated water area utilizing the water purifying functions of various plants and microorganisms wherein metal net materials like stainless steels shaped into concaves to match the empty center of waste tires.

6. The system for improving the total water qualities in an eutrophicated and contaminated water area utilizing the water purifying functions of various plants and microorganisms wherein in order to form a gap of around 2 to 5 centimeters made from cushion materials are inserted between the metal met materials like stainless steels and the surface of waste tires.

7. The system for improving the total water qualities in an eutrophicated and contaminated water area utilizing the water purifying functions of various plants and microorganisms wherein the waste resin foams are stuffed into the hollow parts of waste tires, where bolts and nuts are used to fix the metal net material lying between buoyant materials.

8. The system for improving the total water qualities in an eutrophicated and contaminated water area utilizing the water purifying functions of various plants and microorganisms wherein the buoyant materials like waste resin foams are put into bags with air permeability and retractility, packed with natural rubber, and then stuffed into the waste tires.

9. The system for improving the total water qualities in an eutrophicated and contaminated water area utilizing the water purifying functions of various plants and microorganisms wherein all the under-parts, anchors, weights and joints of the floating island are made from materials which can touch the water surface as widely as possible to fully take advantage of plants' and microbes' function in water purification.

10. The system for improving the total water qualities in an eutrophicated and contaminated water area utilizing the water purifying functions of various plants and microorganisms wherein the anchors are made from multi-aperture stones in the form of hook or acute angle to be easily fixed to the bottom.

11. The system for improving the total water qualities in an eutrophicated and contaminated water area utilizing the water purifying functions of various plants and microorganisms wherein the weights are made from multi-aperture stones.

12. The system for improving the total water qualities in an eutrophicated and contaminated water area utilizing the water purifying functions of various plants and microorganisms wherein one or end portion of the sewage is divided to make multi-stage purification tanks, oxygenation-aeration equipment utilizing different drop height is provided on each of the purification tank so as to purify one by one the raw water taken from the entrance of sewage disposal, the bottom of purification tanks is covered with multi-aperture materials suitable for the growth of attached plants and microbes which are chosen to match the features of raw water in purification. and an water area is set to distinguish the raw water from the disposed water, so that no artificial energy source is consumed in the whole process. and all the plants and microbes are taken advantage of to improve water and meanwhile to dispose eutrophication.

13. The system for improving the total water qualities in an eutrophicated and contaminated water area utilizing the water purifying functions of various plants and microorganisms wherein manageable and profitable plants which can grow in water to absorb nitrogen and phosphorus without causing harm to surroundings are chosen to dispose water.

14. The system for improving the total water qualities in an eutrophicated and contaminated water area utilizing the water purifying functions of various plants and microorganisms wherein roses vegetables like Chinese toona, coleus blumei and Hibiscus cannabinus can act as purification plants.

15. The system for improving the total water qualities in an eutrophicated and contaminated water area utilizing the water purifying functions of various plants and microorganisms wherein funguses which are obligate halophile, proteolytic or lipolytic, or can decompose plant fibers, or can solidify air and nitrogen in water are chosen as microbes for purification, and one combination or diverse combinations are used subject to the quality of water area for the optimal effect.

16. The system for improving the total water qualities in an eutrophicated and contaminated water area utilizing the water purifying functions of various plants and microorganisms wherein aspergillus, mucor or bac. subtllus can act as proteolytic and lipolytic fungi, Bac. methanigenes and Bac. thermofibrincolus rich in cellulase are used as fungi to decompose plant fibers, Bac. asterosporus and Clostridium pastorianum are used as fungi to solidify air and nitrogen in water, and Torulaarten and Saccharomyces carlsberginesis are used as obligate halophile.

(1) Many lakes, ponds and rivers are polluted by the discharged domestic wastewater containing large quantities of eutrophica stuff such as nitrogen and phosphorus, A water purification system is invented that sets artificial floating island on the water surface. Plants are grown whose roots can absorb eutrophic stuff to dispose water, with anchors at the bottom of water to fix the floating island, heavy hammers to adjust the buoyancy of the island, and the connection materials to connect the island. The anchors, heavy hammers and the connection materials constitute the system structure. And, some aquatic plants able to absorb eutrophic materials and some aerobic and facultative microbes suitable to watery environment are chosen and attached to the lower part of the floating island, anchors, heavy hammers, and connecting parts to dispose water at the surface, the bottom and in the middle. The system can take advantage of the particular plants and microbes to achieve optimal effect.

(2) The waste tires, tire tubes, foam resin materials are used as buoyancy conformation bodies of botanical floating island, and at particular water areas, a great number of recycled materials which produce no deleterious chemicals like environmental hormones can be used to cut costs and to improve water quality effectively and quickly.

(3) The waste foam resin materials are stuffed into the middle of waste tires to increase the buoyancy of the island so that the buoyant component can carry a certain weight of stuff for long. And it can also carry people safely. To be exact, in the case of tires of saloon cars, floating resin materials stuffed into the empty middle of waste tires can increase the buoyancy by 30 percent; thus several buoyancy conformation bodies can be used to carry people.

(4) The waste foam resin materials are stuffed into the empty middle of waste tires, and standardized metal mesh materials like stainless steels which can be manufactured in large quantity are used to carry out the large-scale projects more efficiently and easily.

(5) Metal mesh materials like stainless steels are shaped into concaves to match the empty middle of waste tires which are filled with granule materials like porcelain granules. Meanwhile, moisture can be taken in through roots of plants while pollutants like nitrogen or phosphorus can be removed effectively.

(6) A gap of around 2 to 5 centimeters is made from the cushion materials between the metal mesh materials like stainless steels and the surface of waste tires, so the plants grown on metal mesh on the surface of buoyant tire carriers can stretch their roots into the water through the gap. Thus pollutants can be cleared when roots take in moisture.

(7) The waste foam resin materials are stuffed into the middle of waste tires to form a buoyant-material-made structure, where screws and screw caps are used to fix the metal mesh materials lying between buoyant materials. By doing so, the buoyancy of the structure is surely increased so as to carry a certain weight.

(8) Since it is hard to stuff the scrap-like foam material to the full extent, the buoyant materials like waste foam resins are put into the bags with air permeability and retractility, and are packed with natural rubber, and are then stuffed into the waste tires. The stuffed foam resins can guarantee the buoyancy by totally occupying the gap in the process of stuffing. In other words, the other materials like nylon socks with air permeability and retractility are put into the bag, and are packed with natural rubber, and are finally stuffed into the waste tires to keep the stable buoyancy of island.

(9) All the under-parts, anchors, heavy hammers and joints of the floating island are made from materials which can touch the water surface as widely as possible to fully take advantage of plants' and microbes' function in water purification in an effort to improve the water quality in polluted water areas.

(10) The surface of anchors is made from multi-aperture stones in the form of hook or acute angle in order to be fixed to the bottom to fix the botanical floating island while purifying water.

(11) The surface of heavy hammers is also made from multi-aperture stones to take advantage of attached microbes to dispose the polluted water area.

(12) Use some sewage or the topmost part to make multi-stage purification tanks. And at the entrance of sewage disposal, the raw water will go through purification tanks one by one to be purified. The drop heights of different purification tanks are used to design the waterfall-like, contact oxygenation-aeration equipment. The bottom of purification tanks is covered with multi-aperture materials suitable for the growth of various attached plants and microbes which are chosen to match the features of raw water in purification. A water area is set to distinguish the raw water from the disposed water. The terrain falls rather than the artificial energy source are made the most of in the whole purification to set aeration equipments like artificial waterfalls, to increase the oxygen concentration and to facilitate the microbes' reproduction. Almost without energy resource consuming, the disposal of domestic sewerage is combined with the natural scenery, which will effectively work to reach optimal results.

(13) The manageable and profitable plants which can grow in water to absorb nitrogen and phosphorus without causing harm to surroundings are chosen to dispose water. If the biological purification is best designed to take advantage of natural environment and materials, it can earn ecological benefits no less than those earned by artificial purification system through mechanic process.

(14) Roses, vegetables like Chinese toona, coleus blumei and hibiscus cannabinus can act as purification plants in that they can absorb nitrogen and phosphorus on the one hand, and can act as landscaping on the other. Meanwhile, these plants used for purification are also economically profitable since they can serve as for food, decoration and the like.

(15) The funguses which are obligate halophile, proteolytic or lipolytic can decompose plant fibers or can solidify air and nitrogen in water can be chosen as microbes for purification. Such one combination or diverse combinations are used subject to the quality of water area for the optimal effect. In other words, according to content proportion of protein, fat, fiber or salt in the sewage, microbes vary from one water area to another.

For the optimal effect, such microbes or their corresponding combinations with specific functions are used on the basis of the actual environmental condition in polluted water area.

The system can allow various plants and microbes to grow and to reproduce at the water surface, bottom or in the water, during which polluted waters in the complex conditions will be disposed, even the ecosystem will be restored for the long-term environmental benefit.

(16) As proteolytic and lipolytic fungi, aspergillus, mucor or bac. subtllus can do the job. As fungi to decompose plant fibers, Bac. methanigenes and Bac. thermofibrincolus rich in cellulase can be used. And fungi to solidify air and nitrogen in water, Bac. asterosporus and Clostridium pastorianum can be chosen. And Torulaarten and Saccharomyces carlsberginesis can act as obligate halophile. All these microbes work with plants on the floating island to achieve the optimal effect.

To be exact, these fungi and microbes have their own specific functions in a particular water area. This conclusion has been drawn from inventor's experiment, and the effective purification applicable to a particular pollution condition has already been confirmed.

### BRIEF DESCRIPTION OF THE DRAWINGS

FIG. 1 explains the basic construction of botanical floating island by using a schema graph.

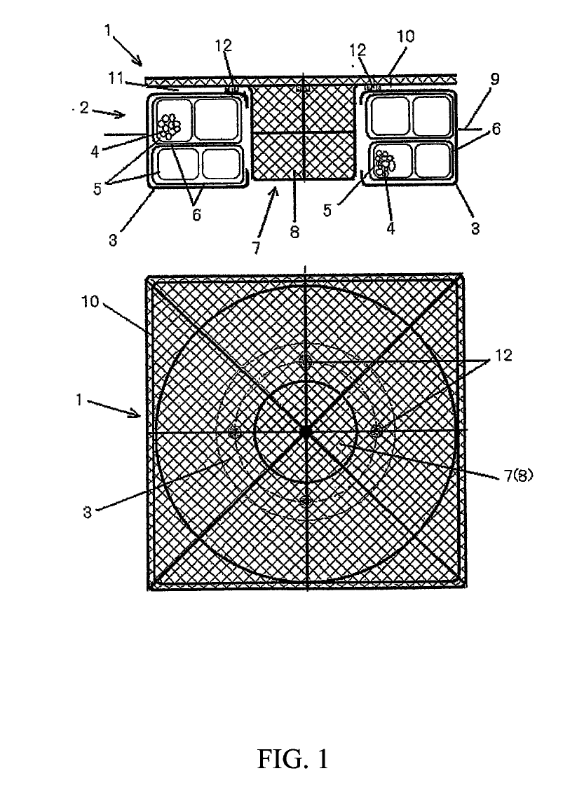

FIG. 2 explains the basic conformation bodies located in the water area. In this figures, reference numeral, 1 represents a botanical floating island, 2 buoyant conformation bodies, 3 waste tires, 4 fragments of foam resin materials, 5 a bag with air permeability and retractility, 6 a sealing bag made of natural rubber, 7 the empty middle of a waste tire, 8 the indention, 9 the water surface, 10 the metal mesh material, 11 space, 12 the cushion material, 13 joints, and 14 the floating road.

### DETAILED DESCRIPTION OF THE INVENTION

The specific cases above-mentioned and inventor's experiment are explained below.

This invention is devoted to purifying the eutrophic wastewater caused by domestic wastewater. And in a large polluted area, the low-costing, recyclable materials instead of artificial ones are used, and plants or microbes with specific functions are also used.

To cut costs, to protect the ecosystem, and to let these plants and microbes play their role in purification, the floating structure is created by the recyclable use of waste tires and foam resin materials. And the simpler processing methods are to be introduced to reuse the wastes, making the invention more feasible.

To the whole floating structure, the recyclable use of waste tires and foam resin materials is very important and crucial. A brief explanation follows.

In terms of the size of tires, generally, these tires from ordinary vehicles or oversize ones can be used. The diameters can range from 10 to 100 centimeters. When foam resin materials are fully stuffed to the middle space, a tire on average can produce buoyancy of 30 to 40 kilograms.

The foam resin is the ideal buoyancy material and is affordable since it comes from wastes. As mentioned, to fully stuff the middle space of tires, granules with diameter less than 1 cm are preferred; thus the larger ones are to be ground to small pieces.

But such granules can not be directly stuffed into the inner space of tires since they may do harm to the environment. So bags made of natural rubber are needed to wrap them up before their stuffing. By doing so, no soluble chemicals will be produced and the second pollution of environmental hormones can be avoided.

However, it is no easy job to fully stuff the light-weighed foam resin into the rubber bags. The invention adopts a special approach. Firstly, little granules of foam resins are put in a bag with air permeability and retractility. Then, the whole bag is sealed by to another rubber bag.

The floating structure made of waste tires and foam resin is almost as buoyant as that of tire stuffed by air. Moreover, the buoyancy will last despite air leak; and most important, the second pollution of environmental hormones caused by soluble chemicals is to be avoided.

The plant-growing floating island, made of the combination of waste tires and foam resin, takes the form of a raft to keep buoyant. The categories of plants may differ freely with the situation of water area, but their height and weight are to be taken into consideration. Since one individual floating component can produce buoyancy of 20 to 30 kilograms, it can surely uphold these plants for one year. When it comes to heavy plants, a module made from the floating road to connect several components can share the weight together and can bear about 100 kg. The experiment proves the safety if structure is safe and its sustainable safety.

There is an explanation about increasing the buoyancy of floating structure. As mentioned above, the central empty space of waste tires when stuffed with foam resin can produce buoyancy. But the floating road to bear a certain weight, or a staff member to walk on should strengthen its unit buoyancy. So a plan to increase the buoyancy is created. After the stuffing, the two sides of centre circle of the tire is infibulated by metal mesh like stainless steel which is fixed by screws and screw caps, and the foam resin is fully filled. The relevant experiment shows that the method can increase the total buoyancy of the whole structure by 30 percent. The buoyancy-growing structure can bear more weight and can be introduced to the floating road.

Examples to illustrate the botanical floating island are followed. The plants to be grown on the island must be able to absorb the nitrogen and phosphorus through their roots. Therefore, the structure should leave space for roots to go through the water. And the mesh basket can let roots do so. But the soil needed by the plants may escape through the nets to the water to cause pollution.

To solve this problem, a micro-porous porcelain granulel whose diameter is larger than metal mesh basket is used to substitute soil to fix the plants and supply their roots with water and air. The kind of granule mainly made of waste porcelains is affordable, and cab be used in large quantities. It is air-venting and moist-keeping so as to supply plants with air and water like soil does. Thus both aquatic plants and terrestrial ones can be grown on the floating island. The invention applies better to the terrestrial plants which can absorb nitrogen and phosphorus 10 to 20 times as much as aquatic plants do.

Additionally, the millipores of porcelain granule containing much air is no heavier than water, even is a lot lighter than water. when situation permits, plants may be directly grown in the water instead on the floating island.

The micro-porous porcelain granulel which works well on purification can also be used at the bottom of water where microbe attached to them can discompose pollutants.

As mentioned above, chart 1 shows the basic construction of botanical floating island. The floating body 2, waste tire 3, and the stuffed waste foam resin 4 are installed into the bag with retractility and air penetrability 5, and are sealed by the rubber bag 6. The whole body is then stuffed into the inside of waste tier 3. By doing so, the granular foam resin can be sealed fully to avoid being scattered into the water.

The hollow part 8 of metal mesh basket made from stainless steel is embedded into the empty space 7. The space is filled by micro-porous porcelain granules, on which corresponding terrestrial plants are grown according to different water areas. The half of hollow part 8 is soaked under the water surface 9. Water can penetrate through micro-cells to reach the half above. So with the plants growing, nitrogen or phosphorus can be absorbed soon. In addition, the bamboo-made hollowed basket can do the same thing.

The waste tire 3 and hollowed basket 8 made of metal mesh materials like stainless steel combine to be a whole body. Also baskets of other shapes can hold proper plants. Since the roots of plants go through nets to absorb nitrogen or phosphorus, the plants which resemble aquatic plants can be grown in the outside above the hollowed part. The cushion material 12 is placed between waste tire 3 and metal mesh 10 to make some room 11.

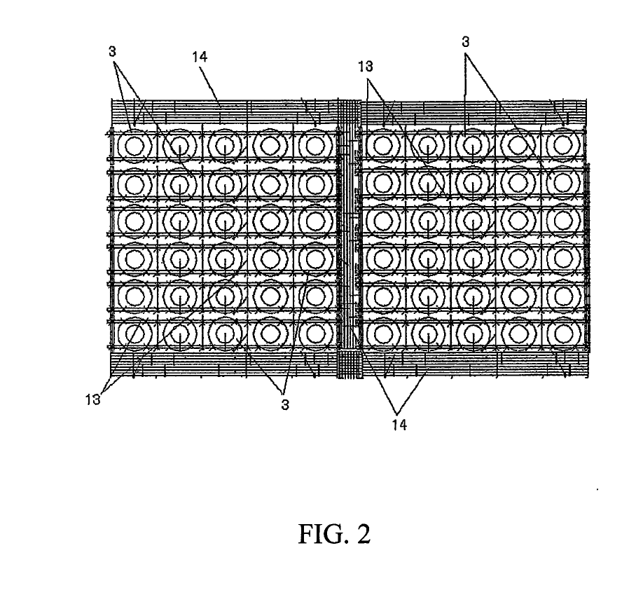

Several basic conformation bodies of plural botanical floating island 1 are combined to form a raft applicable to wild water areas. The examples for plural combinations are shown in the FIG. 2. That is, several connection materials 13 combine to form some plural structures, and all combine to make a large botanical floating island 1. The light, highintensity, low-costing recyclable materials are chosen as connection stuff, and nothing causing side effects will be used in the light of the invention.

Several plural basic conformation bodies combine to form a whole shape of botanical floating island, and it is freely designed in line with the terrain of polluted water area. The invention by using recyclable materials to cut cost is rewarded with more effects beyond the experiment. The floating road 14 made from basic conformation bodies to increase buoyancy is safe to walk on.

The invention takes advantage of various plants on the floating island to improve water, and uses micro-porous porcelain granulels to fix anchors, heavy bobs of island 1. In accordance with actual conditions, different combinations of aquatic plants, microbes and fungi are dispersed to the surface, middle, and bottom of water area for all-round purification.

Also a systematic plan is proposed to improve water quality by making use of terrains. If there are several differences of level in a polluted water area, it can be intercepted into more than 2 stages, and water quality will be improved as it flows upward. According to the terrain of polluted rivers, lakes flowing through, the terrain where sewage enters can act as a multi-stage purification facility, so the sewage can be disposed before entering the lake to avoid more pollution.

According to the pollution condition of different stages, proper surroundings are prepared to match different plant association or micro-flora for their survival and reproduction. While botanical floating island is being used, micro-porous porcelain granulels may be distributed to cover the bottom of water to make a suitable environment for these plants and microbes to grow and reproduce, and to increase the oxygen content by aeration in water flowing through stages for aerobes' reproduction.

With the minimum maintenance and management, this system needs neither manual work nor energy consumption, and causes no harm to surroundings.

The following embodiments can prove the purification effect by using specific plants to dispose polluted water areas.

### Embodiments 1

Plant used: China rose

It has been applied to the water disposal in Dianchi, Yunnan Province. China rose, which can reproduce easily when inserted to water, can effectively absorb nitrogen and phosphorus. On the floating island 30-centimeter-high China roses are planted.

It turns out that averagely every single China rose can annually absorb 236.5 g of nitrogen and 1.225 g of phosphorus. If 4 China roses are planted within an area of 1 square meter, on average they can take in 0.946 kg of nitrogen and 0.0049 kg of phosphorus. If 60-square-meter floating island is setup in the 3000-square-meter water area of domestic wastewater, annually, one single China roses can take in 56.76 kg of nitrogen and 0.294 kg of phosphorus. All this has been confirmed.

### Embodiments 2

Plant used: Toona sinensis (A. Juss) Roem

It is used in the water disposal experiment in Dianchi, Yunnan. The tender buds are editable. 100-gram buds contain 120 mg of phosphorus, 4 times as much as that of tomatoes (29 mg), 3.2 times of cucumbers (37 mg), twice of celeries (61 mg), four times of carrots (30 mg). From this, it is concluded that toona sinensis does better in absorbing phosphorus.

### Embodiments 3

Plant used: Coleus blumei

It is used in the water disposal experiment in Dianchi, Yunnan. When panted, the root length of coleus blumei is totally 2.04 m each one. After the start of the experiment, it will grow to 120.29 m every 80 days, around 50 time that of the earlier one. It weighs from 29 g to 206 g or 176 g unequally. The rate of nitrogen purification is 70 percent.

### Embodiments 4

Plant used: Hibiscus cannabinus, hibiscus, Malvaceae, originally planted in West Africa.

It is used in the water disposal experiment in Dianchi, Yunnan. From the spring sowing to autumn harvest, each Hibiscus cannabinus can grow to 4 to 5 meters tall, the under-part diameter reaches 10 cm. since the yield per unit area roughly equals that of timbers, they can act as materials for paper-making, and can also absorb nitrogen and phosphorus.

### Embodiments 5

Plant used: China rose, Toona sinensis (A. Juss) Roem, jasmine, pea, aloe, and Gazania hybrida, and so on.

From April 2004 till January 2005, an experiment was conducted in Dianchi, Yunnan. 60 square meters of plants above are grown on the 3000-square-meter floating island rich in nitrogen and phosphorus. After 5 months, the result is shown in the table below.

| | Raw water | Disposed water | Rate of purification |
|---|---|---|---|
| Total phosphorus | 1.815 | 0.177 | 90.2% |
| Total nitrogen | 12.65 | 1.45 | 88.5% |
| COD | 223.8 | 60.7 | 72.8% |
| BOD | 28.7 | 1.2 | 95.8% |
| SS | 105 | 19 | 82.0% |

Besides nitrogen and phosphorus, the rate of purification of COD, BOD and SS is also high. The result is remarkable.

### INDUSTRIAL APPLICABILITY

The invention can apply to eutrophication lakes, flowing-slowly rivers, park pools and reservoirs, where the average temperature stays above 0° C. so that relevant plants can grow Since recyclable wastes are used for the basic conformation components, the cost is greatly cut. Terrestrial plants are used and are dozens of times more effective than aquatic plants. And more plants lead to more options. For example, in terms of profits, some plants with economic value can be chosen; others which can absorb pollutants like heavy metal can also be chosen.

Additionally, the botanical floating island is strongly current-resistant. And floating road can be made for its maintenance and management.

Water farms, water parks or recycle facilities with filtering and forestation can be established in a particular water area. So it has many applicable advantages to be introduced to industry.

We claim:

1. A system for improving the total water qualities in an eutrophicated and contaminated water area utilizing the water purifying functions of various plants and microorganisms, the system comprising:
a floating inland with plants; wherein the plants, which have functions of absorbing eutrophication components from the roots and thus purifying water, are planted and grown on the island;
an anchor for fixing the floating island with plants to the bottom;
a weight for controlling the floating conditions of the floating island with plants; and
a connecting member for connecting the floating island with plants, an anchor the a weight, wherein an aquatic plant or an aerobic or anaerobic microorganism capable of absorbing eutrophication components is stuck to at least any of the lower part of the floating island with plants, the anchor, the weight and the connecting member in a manner suitable for the environmental conditions of the water area in which the system is provided, thereby achieving an effect of improving the water qualities simultaneously at all of the water surface, the under water part and the bottom.

2. The system for improving the total water qualities in an eutrophicated and contaminated water area utilizing the water purifying functions of various plants and microorganisms as claimed in claim 1, wherein as buoyancy conformation part of botanical floating island, waste tires, tire tubes, and waste foam materials are utilized.

3. The system for improving the total water qualities in an eutrophicated and contaminated water area utilizing the water purifying functions of various plants and microorganisms as claimed in claim 1, wherein buoyant materials such as waste resin foams are stuffed into the middle of waste tires to increase the overall buoyancy of the island.

4. The system for improving the total water qualities in an eutrophicated and contaminated water area utilizing the water purifying functions of various plants and microorganisms as claimed in claim 3, wherein the buoyant materials such as waste resin foams are stuffed into the middle of waste tires, and a metal netting made from stainless steel is used.

5. The system for improving the total water qualities in an eutrophicated and contaminated water area utilizing the water purifying functions of various plants and microorganisms claimed in claim 1, wherein metal net materials like stainless steels shaped into concaves to match the empty center of waste tires.

6. The system for improving the total water qualities in an eutrophicated and contaminated water area utilizing the water purifying functions of various plants and microorganisms as claimed in claim 1, wherein in order to form a gap of around 2 to 5 centimeters made from cushion materials are inserted between the metal met materials like stainless steels and the surface of waste tires.

7. The system for improving the total water qualities in an eutrophicated and contaminated water area utilizing the water purifying functions of various plants and microorganisms as claimed in claim 4, wherein the waste resin foams are stuffed into the hollow parts of waste tires, where bolts and nuts are used to fix the metal net material lying between buoyant materials.

8. The system for improving the total water qualities in an eutrophicated and contaminated water area utilizing the water purifying functions of various plants and microorganisms claimed in claim 1, wherein the buoyant materials like waste resin foams are put into bags with air permeability and retractility, packed with natural rubber, and then stuffed into the waste tires.

9. The system for improving the total water qualities in an eutrophicated and contaminated water area utilizing the water purifying functions of various plants and microorganisms as claimed in claim 1, wherein all the under-parts, anchors, weights and joints of the floating island are made from materials which can touch the water surface as widely as possible to fully take advantage of plants’ and microbes' function in water purification.

10. The system for improving the total water qualities in an eutrophicated and contaminated water area utilizing the water purifying functions of various plants and microorganisms as claimed in claim 1, wherein the anchors are made from multi-aperture stones in the form of hook or acute angle to be easily fixed to the bottom.

11. The system for improving the total water qualities in an eutrophicated and contaminated water area utilizing the water purifying functions of various plants and microorganisms as claimed in claim 1, wherein the weights are made from multi-aperture stones.

12. The system for improving the total water qualities in an eutrophicated and contaminated water area utilizing the water purifying functions of various plants and microorganisms as claimed in claim 1, wherein one or end portion of the sewage is divided to make multi-stage purification tanks, oxygenation-aeration equipment utilizing different drop height is provided on each of the purification tank so as to purify one by one the raw water taken from the entrance of sewage disposal, the bottom of purification tanks is covered with multi-aperture materials suitable for the growth of attached plants and microbes which are chosen to match the features of raw water in purification. and an water area is set to distinguish the raw water from the disposed water, so that no artificial energy source is consumed in the whole process. and all the plants and microbes are taken advantage of to improve water and meanwhile to dispose eutrophication.

13. The system for improving the total water qualities in an eutrophicated and contaminated water area utilizing the water purifying functions of various plants and microorganisms as claimed in claim 1, wherein manageable and profitable plants which can grow in water to absorb nitrogen and phosphorus without causing harm to surroundings are chosen to dispose water.

14. The system for improving the total water qualities in an eutrophicated and contaminated water area utilizing the water purifying functions of various plants and microorganisms as claimed in claim 13, wherein roses vegetables like Chinese toona, coleus blumei and Hibiscus cannabinus can act as purification plants.

15. The system for improving the total water qualities in an eutrophicated and contaminated water area utilizing the water purifying functions of various plants and microorganisms as claimed in claim 1, wherein funguses which are obligate halophile, proteolytic or lipolytic, or can decompose plant fibers, or can solidify air and nitrogen in water are chosen as microbes for purification, and one combination or diverse combinations are used subject to the quality of water area for the optimal effect.

16. The system for improving the total water qualities in an eutrophicated and contaminated water area utilizing the water purifying functions of various plants and microorganisms as claimed in claim 15, wherein aspergillus, mucor or bac. subtllus can act as proteolytic and lipolytic fungi, Bac. methanigenes and Bac. thermofibrincolus rich in cellulase are used as fungi to decompose plant fibers, Bac. asterosporus and Clostridium pastorianum are used as fungi to solidify air and nitrogen in water, and Torulaarten and Saccharomyces carlsberginesis are used as obligate halophile.

17. A system for improving the total water qualities in an area of eutrophicated and contaminated water, the system comprising:
an island floating on the surface of the water and on which are grown plants that absorb eutrophication components from the roots of the plants;
an anchor tethering the floating island to the bottom of the water area;
a weight that controls the floating conditions of the floating island;
a connecting member that connects the floating island, the anchor, and the weight together, wherein
an aquatic plant or an aerobic or anaerobic microorganism capable of absorbing eutrophication components is provided on at least a lower part of the system, the system thereby improving the water qualities at all of the water surface, beneath the water surface, and at the bottom of the water area.

18. A method of improving the total water qualities in an area of eutrophicated and contaminated water, the method comprising:
providing a system including an island floating on the surface of the water and on which are grown plants, an anchor that tethers the floating island to the bottom of the surface area, a weight that controls the floating conditions of the floating island, a connecting member that connects the floating island, the anchor, and the weight together, and an aquatic plant or an aerobic or anaerobic microorganism provided on at least a lower part of the system, the method comprising:
drawing eutrophication components from the water into the roots of the plants and, using the plants, absorbing the eutrophication components; and
using the aquatic plant or an aerobic or anaerobic microorganism, absorbing eutrophication components from the water, whereby the system improves the water quality at all of the water surface, beneath the water surface, and at the bottom of the water area.
